(19) United States
(12) Patent Application Publication
(10) Pub. No.: US 2015/0316830 A1
(43) Pub. Date: Nov. 5, 2015

(54) OPTICAL LOGIC CIRCUIT OPERATING BY CONTROLLING REFLECTION OF LIGHT AND COMPUTING DEVICE USING SAID OPTICAL LOGIC CIRCUIT

(71) Applicant: KOREA ADVANCED INSTITUTE OF SCIENCE AND TECHNOLOGY, Daejeon (KR)

(72) Inventors: Hyo-Hoon PARK, Gangwon-do (KR); Jong Hun KIM, Daejeon (KR); Mu Hee CHO, Daejeon (KR); Tae-Woo LEE, Daejeon (KR)

(21) Appl. No.: 14/436,819

(22) PCT Filed: Oct. 17, 2013
(86) PCT No.: PCT/KR2013/009271

§ 371 Date: Apr. 17, 2015

(30) Foreign Application Priority Data
Oct. 17, 2012 (KR) 10-2012-0115199

(51) Int. Cl. G02F 1/313

(52) U.S. Cl. CPC G02F 1/3137

(57) ABSTRACT

The disclosed optical logic circuit operating by controlling the reflection of light comprises: a first waveguide, at least a portion of which is formed into the shape of a straight line; a second waveguide branched at a predetermined angle from the first waveguide; and a first reflector having a refractive index that varies based on a first input signal, the first reflector selecting either the first waveguide or the second waveguide as a pathway of light. The value of the signal of a first output terminal provided through the first waveguide and the value of the signal of a second output terminal provided through the second waveguide can be adjusted using the first input signal.

### TECHNICAL FIELD

The present disclosure relates to optical logic circuits and arithmetic devices using the optical logic circuit, and more particularly, to optical logic circuits, which are implemented using a main waveguide, a branch waveguide split from the main waveguide, and a reflector capable of controlling the path of light, and arithmetic devices using the optical logic circuit.

### BACKGROUND ART

Korean Patent Application No. 10-2010-0066834 (hereinafter referred to as ‘Prior art 1’) discloses an optical communication device switching an optical signal using a reflection output part which forms a small angle at a side of a main core. However, since in Prior art 1 the reflection output part branches with a small angle from the main core, it could be restrictive only to a structure which switches an optical signal into a waveguide forming a small angle.

Most prior arts relative to optical logic gate are concerned with modes of performing logical computations by controlling phase interferences or absorption of light.

### DISCLOSURE

### Technical Problem

The present disclosure is directed to provide optical logic circuits that operate with control of light reflection, capable of determining to reflect or transmit light by control of refractive index to change an optical pathway and perform logical computation, and arithmetic devices using the optical logic circuit.

### Technical Solution

In accordance with an aspect of the present disclosure, an optical logic circuit operating with light reflection control may include: a first waveguide configured to have at least a portion formed into a shape of straight line; a second waveguide configured to branch with an angle from the first waveguide; and a first reflector configured to change a refractive index by a first input signal and control a pathway of light to be selected into one of the first waveguide and the second waveguide, wherein the first input signal may be used to control a signal value of a first output terminal through the first waveguide and a signal value of a second output terminal through the second waveguide.

The optical logic circuit may further include: a third waveguide configured to branch with an angle from the first waveguide; and a second reflector configured to change a refractive index by a second input signal and control a pathway of light to be selected into one of the first waveguide and the third waveguide, wherein an end of the third waveguide may be configured to meet the second waveguide and join with a fourth waveguide; and the first input signal and the second input signal may be used to control a signal value of a first output terminal through the first waveguide and a signal value of a fourth output terminal through the fourth waveguide.

Additionally, the optical logic circuit may further include: a fifth waveguide configured to couple with the second waveguide and lead light straight; a sixth waveguide configured to branch with an angle from the fifth waveguide; and a third reflector configured to change a refractive index by a third input signal and control a pathway of light to be selected into one of the fifth waveguide and the sixth waveguide, wherein an end of the first waveguide and an end of the fifth waveguide may meet to join into one waveguide; and the first input signal and the second input signal may be used to control a signal value of an output terminal of the one waveguide, in which the end of the fifth waveguide and the end of the first waveguide meet and join, and a signal value of a sixth output terminal through the sixth waveguide.

Additionally, the optical logic circuit may further include: a seventh waveguide configured to couple with the second waveguide and lead light straight; an eighth waveguide configured to branch with an angle from the seventh waveguide; a fourth reflector configured to change a refractive index by a fourth input signal and control a pathway of light to be selected into one of the seventh waveguide and the eighth waveguide; a ninth waveguide configured to branch with an angle from the first waveguide; and a fifth reflector configured to change a refractive index by a fifth input signal and control a pathway of light to be selected into one of the first waveguide and the ninth waveguide, wherein an end of the eighth waveguide may be configured to meet and join with the first waveguide and an end of the ninth waveguide is configured to meet and an end of the seventh waveguide to join with the seventh waveguide; and the first input signal, the fourth input signal, and the fifth input signal may be used to control a signal value of a first output terminal through the first waveguide and a signal value of a seventh output terminal through the seventh waveguide.

Additionally, the optical logic circuit may further include: a tenth waveguide configured to branch with an angle from the fourth waveguide; and a sixth reflector configured to change a refractive index by a sixth input signal and control a pathway of light to be selected into one of the fourth waveguide and the tenth waveguide, wherein the first input signal, the second input signal, and the sixth input signal are used to control a signal value of a first output terminal through the first waveguide, a signal value of a fourth output terminal through the fourth waveguide, and a signal value of a tenth output terminal through the tenth waveguide.

Additionally, the optical logic circuit may further include: an eleventh waveguide configured to couple with the tenth waveguide and lead light straight; a twelfth waveguide configured to branch with an angle from the first waveguide; a thirteenth waveguide configured to branch with an angle from the fourth waveguide; a fourteenth waveguide configured to branch with an angle from the eleventh waveguide; a seventh reflector configured to change a refractive index by a seventh input signal and control a pathway of light to be selected into one of the first waveguide and the twelfth waveguide; an eighth reflector configured to change a refractive index by an eighth input signal and control a pathway of light to be selected into one of the fourth waveguide and the thirteenth waveguide; and a ninth reflector configured to change a refractive index by a ninth input signal and control a pathway of light to be selected into one of the eleventh waveguide and the fourteenth waveguide, wherein an end of the twelfth waveguide and an end of the fourteenth waveguide may be configured to meet and join with the fourth waveguide; and an end of the thirteenth waveguide is configured to meet and join with the eleventh waveguide.

Additionally, the seventh input signal, the eighth input signal, and the ninth input signal may be used to select a part of the first waveguide, the fourth waveguide, and the eleventh waveguide as an output terminal of a final signal to select different logical functions.

In accordance with another aspect of the present disclosure, an optical logic circuit operating light reflection control may include: at least two main waveguides configured to lead light straight; at least one branch waveguide configured to diverge from one of the at least two main waveguides and meet and join with the other of the at least two main waveguides; and at least one input signal reflector configured to change a refractive index by an input signal and control a pathway of light to be selected into one of the at least two main waveguides and the branch waveguide, wherein an input signal of each input signal reflector may be used to control a signal value of each output terminal of the main waveguides.

Additionally, the optical logic circuit may further include: at least output-terminal leading waveguide configured to branch from one of the at least two main waveguides, and meet and join with the other of the at least two main waveguides; and at least one output-terminal controlling reflector configured to change a refractive index by a control signal and select a pathway of light to be selected into one of the at least two main waveguides and the output-terminal leading waveguide, wherein the control signal, which is input, may be used to select a part of the at least two main waveguide, which are shaped in a straight line, as an output terminal of a final signal.

In accordance with another aspect of the present disclosure, the optical logic circuit may further include: at least one signal inverter configured to output an input signal into a non-inverse signal or an inverse signal, wherein an output signal of the signal inverter may be input into each input terminal of the at least one reflector. Additionally, In accordance with another aspect of the present disclosure, the optical logic circuit may further include: a signal converter configured to convert a signal, which is output to an output terminal of the final signal, into a signal that is required from the next input terminal.

In accordance with still another aspect of the present disclosure, arithmetic devices may include: two or more optical logic circuits, wherein the at least two or more optical logic circuit may include: at least two main waveguides configured to lead light straight; at least one branch waveguide configured to diverge from one of the at least two main waveguides and meet and join with the other of the at least two main waveguides; and at least one input signal reflector configured to change a refractive index by an input signal and control a pathway of light to be selected into one of the at least two main waveguides and the branch waveguide, wherein an input signal of each input signal reflector may be used to control a signal value of each output terminal of the main waveguides. Additionally, the arithmetic device may further include: a first arithmetic unit in which one or more of the optical logic circuits are coupled in parallel; and a second arithmetic unit in which one or more of the optical logic circuits are coupled in parallel. Additionally, the arithmetic device may further include: an input terminal distributer configured to one or more of parallel output terminals, which are provided from the first arithmetic unit, into parallel input signals of the second arithmetic unit.

### Advantageous Effects

According to optical logic circuits, which operate with control of light reflection, and arithmetic devices using the optical logic circuit, according to embodiments of the present disclosure, it may be allowable to perform logical computation by determining to reflect or transmit light by refractive index control of light to change an optical pathway.

Additionally, according to optical logic circuits operating with control of light reflection, and arithmetic devices using the optical logic circuit, according to embodiments of the present disclosure, it may be even permissible to achieve a faster computation rate because a logical computation in the optical logic circuit is performed by optical signals.

### DESCRIPTION OF DRAWINGS

FIGS. 1A to 1D illustrate an optical logic circuit operating with light reflection control, and tables for showing the operations in accordance with a first embodiment of the present disclosure.

FIGS. 2A to 2C illustrate an optical logic circuit operating with light reflection control, and tables for showing the operations in accordance with a second embodiment of the present disclosure.

FIGS. 3A to 3D illustrate optical logic circuits operating with light reflection control, and tables for showing the operations in accordance with a third embodiment of the present disclosure.

FIGS. 4A and 4B illustrate an optical logic circuit operating with light reflection control, and a table for showing the operation in accordance with a fourth embodiment of the present disclosure.

FIGS. 5a to 5c illustrate an optical logic circuit operating with light reflection control, and tables for showing the operations in accordance with a fifth embodiment of the present disclosure.

FIGS. 6a to 6c illustrate an optical logic circuit operating with light reflection control, and tables for showing the operations in accordance with a sixth embodiment of the present disclosure.

FIGS. 7a and 7b illustrate an optical logic circuit and a table for showing the operation in accordance with a seventh embodiment of the present disclosure.

FIG. 8 illustrates an optical logic circuit operating with light reflection control in accordance with an eighth embodiment of the present disclosure.

FIG. 9 illustrates a arithmetic device in accordance with an embodiment of the present disclosure.

### BEST MODE

### Mode for Invention

Hereinafter, the attached drawings will be referred to describe optical logic circuits operating with light reflection control, and computation devices using the optical logic circuit in accordance with embodiments of the present disclosure.

Various embodiments of the present disclosure as described hereinafter are provided to detail features of the present disclosure, not to restrict or concretely define the scope of inventive concept thereof. Rather, it will be properly construed that all of modifications, alterations, or variations derivable by those skilled in the art may be included in the scope of the present disclosure.

Now the principle of optical logic circuits according to embodiments of the present disclosure will be described schematically.

Optical logic circuits according to the present disclosure may be formed of a main waveguide in which light travels straight, and a branch waveguide which makes light stray in a small angle. Additionally, a reflector with a variable refractive index is installed around a diverging point (or intersection) between the main waveguide and the branch waveguide. The optical logic circuit may control a refractive index of the reflector to turn light, which passes the reflector, into a pass state in which the light travels towards the main waveguide, or into a reflection state in which the light is reflected toward the branch waveguide. In the optical logic circuit according to the present disclosure, these two states may be correspondent with input signals ‘0’ and ‘1’ of binary computation.

A method of controlling a refractive index with an input signal in the reflector may be used by adopting various ways such as electro-optic effect, electro-absorption effect, plasma dispersion effect of electron and hole carriers, thermo-optic effect, acousto-optic effect, nonlinear effect, surface plasmonic effect, and so on. Desirably, it may be allowable to form a p-n junction in a waveguide of semiconductor and control a refractive index of the reflector by applying an electric voltage or injecting carriers into the p-n junction. Otherwise, it may be also allowable to provide means of injecting a current into a polymer member and then controlling a refractive index by a thermo-optic effect. It may be also permissible to provide means of applying a voltage to a polymer member and then controlling a refractive index by a thermo-optic effect. In adopting such means to embodiments of the present disclosure, input signals ‘0’ and ‘1’ may be input with different quantities of voltages or currents applied into the reflector. In several materials, a refractive index may be controlled by light under a nonlinear effect and, if embodiments of the present disclosure use this effect, input signals ‘0’ and ‘1’ may be input varying intensity of light thereof.

In embodiments of the present disclosure, light used for a computation process may be incident on an optical input port of a waveguide by using light of a continuous wave. An input signal ‘0’ or ‘1’ for computation may be input to a refractive-index control control node of the reflector, and an optical beam may determine a pass state or a reflection state by the input signal in the reflector. An output signal after the computation may be output through one of optical output ports in a form of optical If light is output from a specific one of the optical output ports, an output signal may be determined as corresponding to ‘1’. Unless there is no light from a specific one of the optical output ports, an output signal may be determined as corresponding to ‘0’. Contrarily, if light is output from a specific one of the optical output ports, an output signal may be determined as corresponding to ‘0’; and unless there is no light from a specific one of the optical output ports, an output signal may be determined as corresponding to ‘1’. Embodiments of the present disclosure will be hereinafter described about an optical logic circuit under the former condition of determination.

For reference, most materials have very small variation rates of refractive indexes smaller than 0.01 due to the aforementioned effects. If a variation rate of refractive index, (n₁−n₂)/n₁, is very small, a critical angle becomes smaller to be some degree (°).

As an example, for a silicon semiconductor material, if p-type or n-type impurities are doped, a refractive index becomes lower than that of the intrinsic state due to carriers of electrons and holes. This effect causes the refractive index to be theoretically lower by 5×10⁻¹˜1×10⁻¹ than that of an intrinsic silicon (n₁ is about 3.5 times) in the range of concentration 5×10¹⁷˜1×10²⁰ of acceptors and donors. A difference of refractive index between doped and intrinsic states, Δn=n₁−n₂, is in the range of −0.0005˜−0.1 and (n₁−n₂)/n₁ is in −0.00015˜−0.03. Within the range of refractive index, a critical angle is in 1°˜15°. In regard even to other materials, variations of refractive indexes due to electric fields or doping are not over the aforementioned variation rate of refractive index. Considering variation ranges of refractive indexes, which are obtained by electric fields, even for generally usable materials, a critical angle becomes in small within a range of 20°. Therefore, as used in in the description below, the term ‘small angle reflection’ may mean reflection that is ranged within 20° of which is capable of substantially obtaining total reflection by variation of refractive index. Embodiments of the present disclosure may use the principle that an optical pathway can be changed into the aforementioned small-ranged total reflection angle by the aforementioned small-ranged refractive index range.

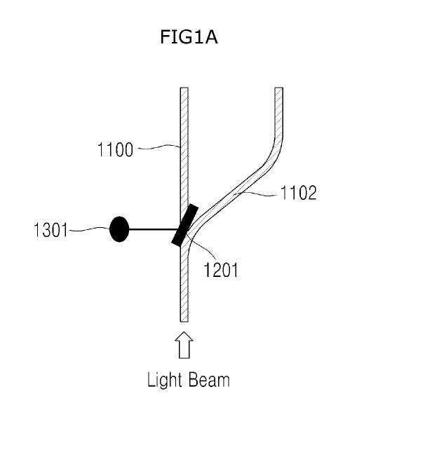

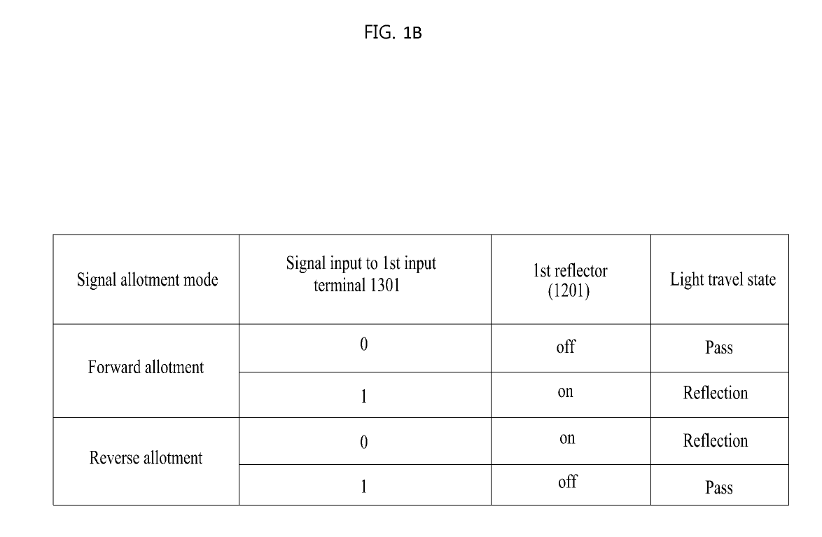

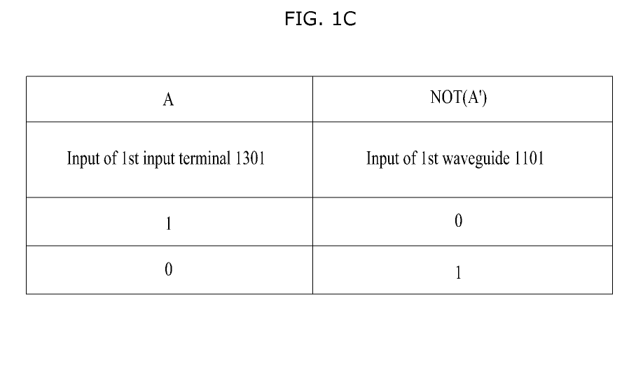

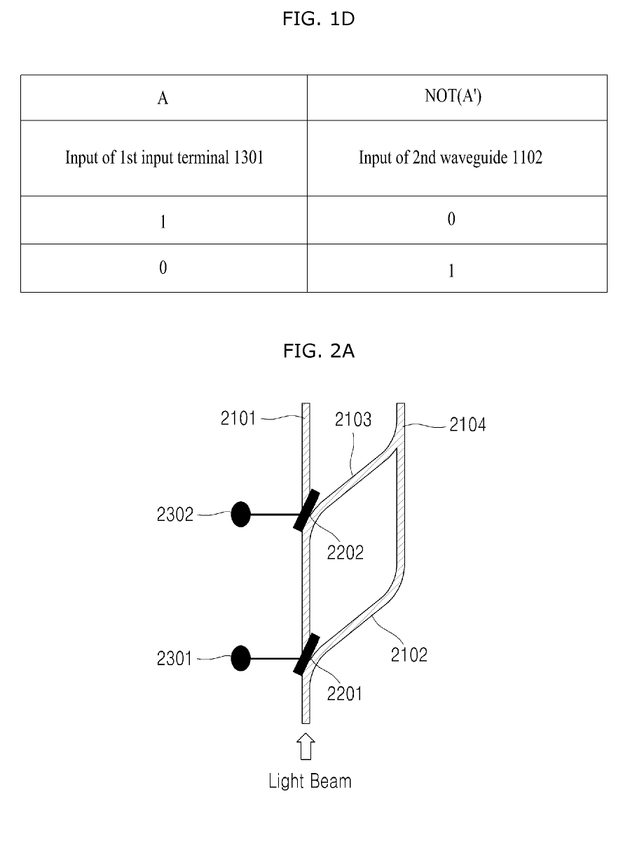

FIGS. 1A to 1D illustrate an optical logic circuit operating with light reflection control, and tables for showing the operation in accordance with a first embodiment of the present disclosure.

FIG. 1A illustrates an optical logic circuit according to the first embodiment of the present disclosure. As can be seen from FIG. 1A, the optical logic circuit may include a first waveguide 1101, a second waveguide 1102, and a first reflector 1201.

It may be desired for the first waveguide 1101, on which light is incident, to have at least at least a portion which is formed into the shape of a straight line. It may be also desired for the first waveguide 1101 to be entirely formed into the shape of a straight line. The second waveguide 1102 may be formed into the shape of branch making an angle with the first waveguide 1101. The first reflector 1201 according to this this embodiment of the present disclosure may be disposed at an area in which the second waveguide 1102 branches from the first waveguide 1101, and control a refractive index by using a first input signal which is supplied from a first input terminal 1301. The first reflector 1201 may respond to a first input signal to change a refractive index and then control a pathway of light to be selected into one of the first waveguide 1101 or the second waveguide 1102.

The optical logic circuit according the first embodiment of the present disclosure may feature to use the first input signal to control a signal value of a first output terminal through the first waveguide 1101, and a signal value of a second output terminal through the second waveguide 1102 to operate as a logic gate.

FIG. 1B shows a table for summarizing an operation of the optical logic circuit of the first embodiment according to a signal allotment method of the present disclosure. As can be seen from FIG. 1B, the optical logic circuit according to the first embodiment of the present disclosure may be operable in two modes according to the signal allotment method.

If the first input signal input into the input terminal 1301 of the first reflector 1201 is ‘1’, a first mode as a forward allotment mode may control the first reflector 1201 to operate to output light to a second output terminal through the second waveguide 1102. In the first mode, if the first input signal is ‘0’, the first reflector 1201 may be disabled to be into a pass state. Then, light may be output to the first output terminal through the first waveguide 1101.

If the first input signal input to the input terminal 1301 of the first reflector 1201 is ‘0’, a second mode as a reverse allotment mode may control the first reflector 1201 to operate to be in a reflection state, and thereby output light into the second waveguide 1102. In the first mode, if the first input signal is ‘1’, the first reflector 1201 may be disabled to be in a pass state. Then, light may be output to the first output terminal through the first waveguide 1101.

The operation(s) of the first mode and/or the second mode may be also applicable to other embodiments, the first embodiment as well.

FIG. 1C shows the first input signal, which is input into the first input terminal 1301, and a signal of the first output terminal through the first waveguide 1101, in the first mode of the optical logic circuit according to the first embodiment of the present disclosure illustrated in FIG. 1A.

As can be seen from FIG. 1C, in the forward allotment mode as the first mode, the optical logic circuit according to the first embodiment of the present disclosure may operate with the first output terminal which acts as a ‘NOT’ gate.

The first input signal ‘0’ or ‘1’ may be input to a signal input terminal to control a refractive index of the first reflector 1201. In the forward allotment mode, if the first input signal is ‘0’, light may be output through the first output terminal in the pass state. If the first input signal is ‘1’, light may be output through the second output terminal in the reflection state. Assuming that a state where there is light from the first output terminal is determined as corresponding to an output signal of ‘1’ and a state where there is no light from the first output terminal is determined as corresponding to an output signal of ‘0’, a signal of the first output terminal may become ‘1’ when the first input signal is ‘0’, or become ‘0’ when the first input signal is ‘1’. Thus, a signal of the first output signal may operate as a ‘NOT’ gate by resulting in a signal inverse to the first input signal.

Next, FIG. 1D shows the first input signal, which is input into the first input terminal 1301, and a signal of the second output terminal through the second waveguide 1102, in the second mode of the optical logic circuit according to the first embodiment of the present disclosure illustrated in FIG. 1A.

As can be seen from FIG. 1D, in the reverse allotment mode as the second mode, the optical logic circuit according to the first embodiment of the present disclosure may operate as a ‘NOT’ gate.

Different from the forward allotment mode that is the first mode of FIG. 1C, the element acting as a ‘NOT’ gate in FIG. 1D may not be the first output terminal but the second output terminal through the second waveguide 1102.

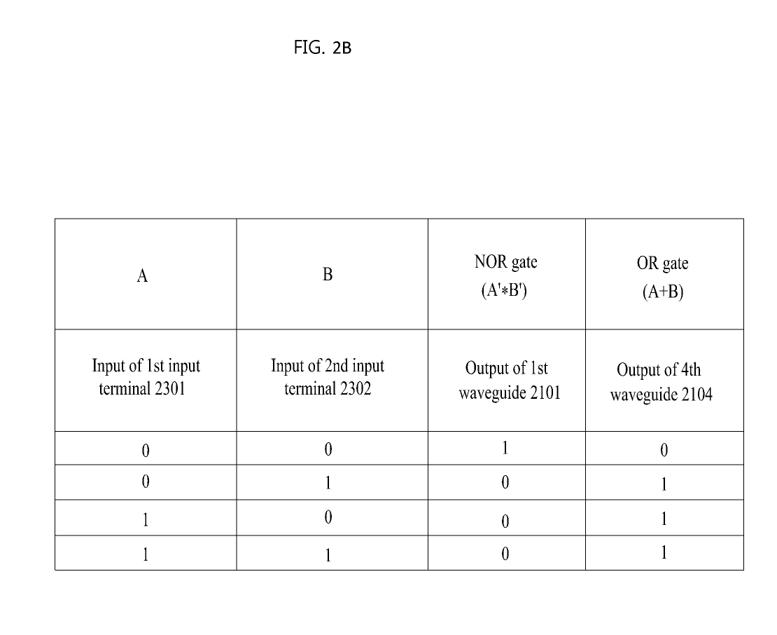

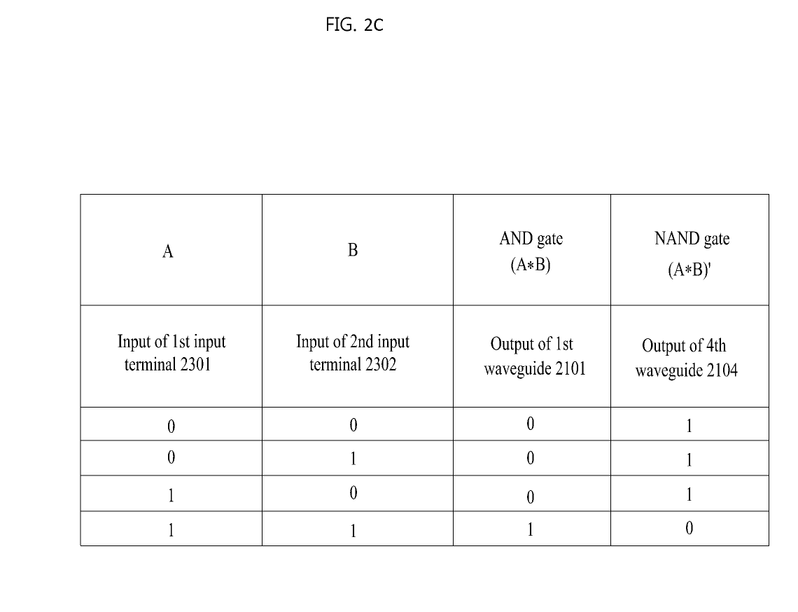

FIGS. 2A to 2C illustrate an optical logic circuit operating with light reflection control, and tables for showing the operation in accordance with a second embodiment of the present disclosure.

As can be seen from FIG. 2A, an optical logic circuit according to the second embodiment of the present disclosure may further include, in addition to a first waveguide 2101, a second waveguide 2102, and a first reflector 2201 which correspond to those of the optical logic circuit of the first embodiment, a third waveguide 2103 branching with an angle from the first waveguide 2101, a fourth waveguide 2104 guiding light to one way after turning its direction from the second waveguide 2102 and coupling with the third waveguide 2103, and a second reflector 2202 disposed on an area, at which the third waveguide 2103 branches from the first waveguide 2101, and configured to control a refractive index by a second input signal from a second input terminal 2302. The second reflector 2202 may change a refractive index in response to the second input signal and control a pathway of light to be selected into one of the first waveguide 2101 and the third waveguide 2103.

In detail, the optical logic circuit according to the second embodiment of the present disclosure may feature that an end of the third waveguide 2103 may meet the second waveguide 2102 and join with the fourth waveguide 2104, and the first input signal and the second input signal may be used to control a signal of a first output terminal through the first waveguide 2101 and a signal of a fourth output terminal through the fourth waveguide 2104 to operate as a logic gate.

The optical logic circuit according to the second embodiment of the present disclosure may be structured in the feature that the first reflector 2201 and the second reflector 2202 are coupled in series on the first waveguide 2101 while the second waveguide 2102 and the third waveguide 2103, which are branch waveguides, are jointed in one way.

FIG. 2B is a table for showing an operation of a first mode by the optical logic circuit according to the second embodiment. If the optical logic circuit of the second embodiment is managed to operate in a reverse allotment mode that is the first mode, an output terminal of the first waveguide 2101 and an output terminal of the fourth waveguide 2104 may operate as a ‘NOR’ gate and an ‘OR’ gate, respectively. When the first input signal is ‘0’ and the second input signal is ‘0’, the first reflector 2201 and the second reflector 2202 may be all turned ‘off’ and light travels straight to output through the output terminal of the first waveguide 2101. When the first input signal is ‘0’ ‘0’ and the second input signal is ‘1’, the first reflector 2201 may be turned ‘off’ and the second reflector 2202 may be turned ‘on’. Then, light may be reflected on the second reflector 2202, after passing the first reflector 2201, and thereafter may output through the output terminal of the fourth waveguide 2104. When the first input signal of the first input terminal 2301 is ‘1’ and the second input signal of the second input terminal 2302 is ‘0’, the first reflector 2201 may be turned ‘on’ and the second reflector 2202 may be turned ‘off’, whereas light may be reflected on the first reflector 2201 for the first time to output through the output terminal of the fourth waveguide 2104. When the first input signal is ‘1’ and the second input signal is ‘1’, the first reflector 2201 and the second reflector 2202 are turned ‘on’ to make light reflected first on the first reflector 2201 and then output through the output terminal of the fourth waveguide 2104. Summarily, an output signal from the output terminal of the first waveguide 2101 may correspond to a arithmetic result of A′*B′ for four cases by a combination with the first input signal A and the second input signal B, as shown in FIG. 2B, and thus may have a function of ‘NOR’ gate. Additionally, an output signal from the output terminal of the fourth waveguide 2104 may correspond to a arithmetic result of A+B, as shown in FIG. 2B, and thus may have a function of ‘OR’ gate.

FIG. 2C is a table showing an operation of a second mode by the optical logic circuit according to the second embodiment of the present disclosure. If the optical logic circuit of the second embodiment is controlled to operate in a reverse allotment mode that is the second mode, the output terminal of the first waveguide 2101 and the output terminal of the fourth waveguide 2104 may operate as a ‘NAND’ gate and a ‘NAND’ gate, respectively.

As aforementioned, it can be understood that the optical logic circuit according to the second embodiment of the present disclosure may operate as one of the ‘NOR’, ‘OR’, ‘AND’, or ‘NAND’ gates.

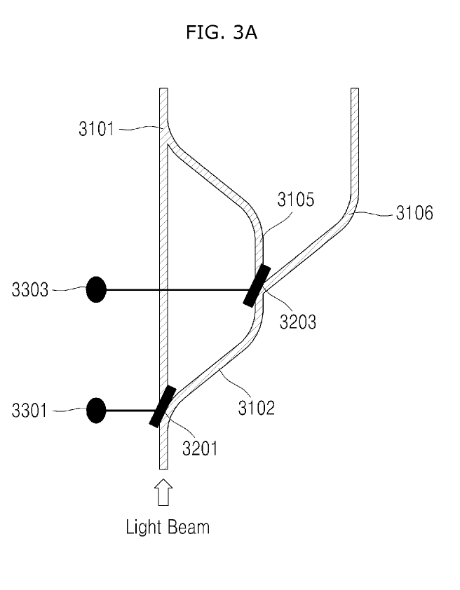

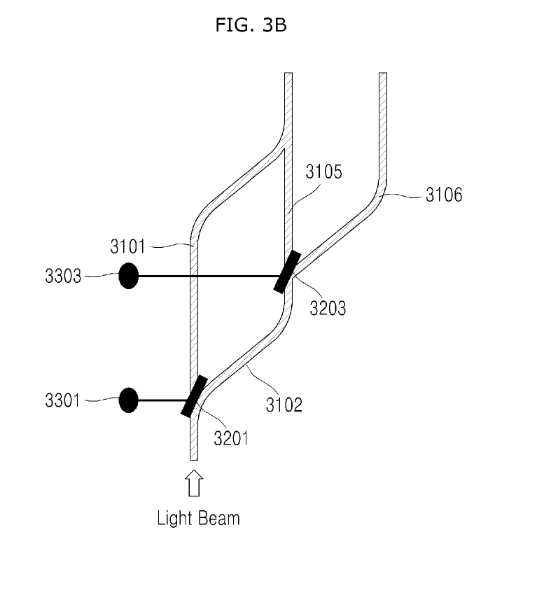

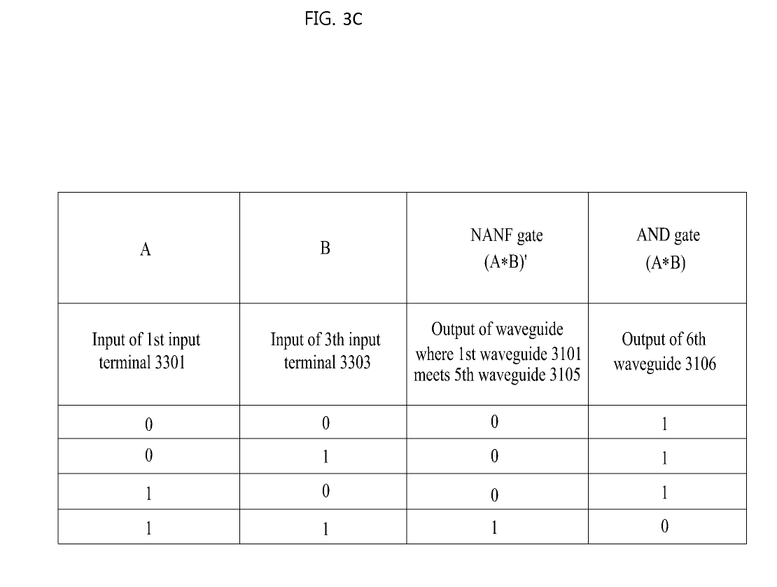

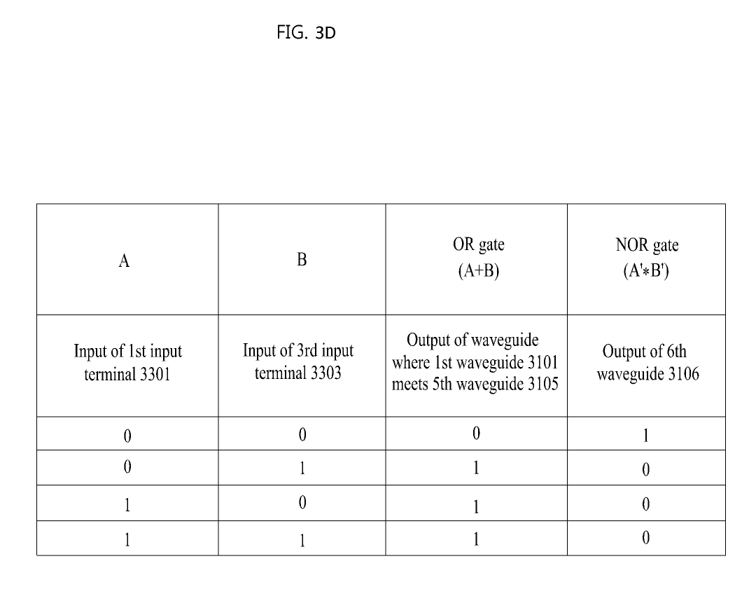

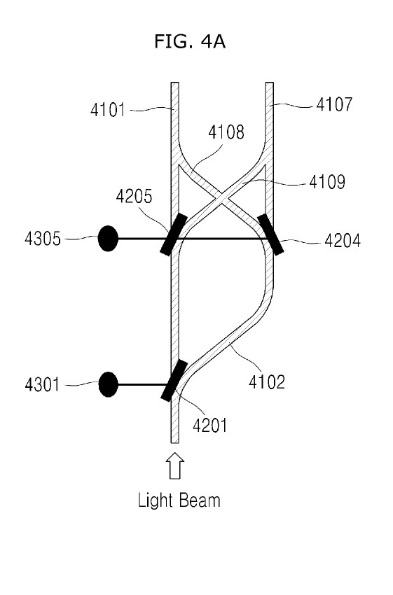

FIGS. 3A to 3D illustrate optical logic circuits operating with light reflection control, and tables for showing the operations in accordance with a third embodiment of the present disclosure.

FIG. 3A exemplarily illustrates the optical logic circuit according to the third embodiment of the present disclosure. The optical logic circuit of FIG. 3A may further include, in addition to a first waveguide 3101, a second waveguide 3102, and a first reflector 3201 which correspond even to those of the optical logic circuit of the first embodiment, a fifth waveguide 3105 coupling with the second waveguide 3102 and guiding light straight, a sixth waveguide 3106 branching with an angle from the fifth waveguide 3105, and a third reflector 3203 disposed on an area, at which the sixth waveguide 3106 branches from the fifth waveguide 3105, and configured to control a refractive index by a third input signal from a third input terminal 3303. The third reflector 3203 may change a refractive index in response to the third input signal and control a pathway of light to be selected into one of the fifth waveguide 3105 and the sixth waveguide 3106.

In detail, the optical logic circuit of FIG. 3A may feature that an end of the fifth waveguide 3105 may meet and join with the first waveguide 3101, and the first input signal and the third input signal may be used to control a signal of a first output terminal through the first waveguide 3101 and a signal of a sixth output terminal through the sixth waveguide 3106 to operate as a logic gate.

FIG. 3B exemplarily illustrates another one of the optical logic circuit according to the third embodiment of the present disclosure. The optical logic circuit of FIG. 3B may be almost same with the optical logic circuit of FIG. 3A, but different in that an end of the first waveguide 3101 may meet and join with the fifth waveguide 3105, and the first input signal and the third input signal may be used to control a signal of a fifth output terminal through the fifth waveguide 3105 and a signal of a sixth output terminal through the sixth waveguide 3106 to operate as a logic gate.

In more detail, among the optical logic circuits according to the third embodiment of the present disclosure, the optical logic circuit shown in FIG. 3A may be structured in a configuration that the first reflector 3201 is installed on the second waveguide 3102 which is a branch waveguide diverged from the first reflector 3201, and the fifth waveguide 3105 which is a main waveguide branching from the third reflector 3201 joins with the first waveguide 3101 which is a main waveguide of the first reflector 3201. Otherwise, FIG. 3B illustrates a structure that the first waveguide 3101 which is a main waveguide diverged from the first reflector 3201 joins with the fifth waveguide 3105 which is a main waveguide of the third reflector 3203.

FIG. 3C is a table showing an operation in a forward allotment mode that is a first mode in the optical logic circuit according to the third embodiment of the present disclosure. As can be seen from FIG. 3C, during the forward allotment mode as the first mode, in the optical logic circuit according to the third embodiment of the present disclosure, a first output terminal or a fifth output terminal may be controlled to act as a ‘NAND’ gate while a sixth output terminal may be controlled to act as an ‘AND’ gate.

As also, FIG. 3D is a table showing an operation in a reverse allotment mode that is a second mode in the optical logic circuit according to the third embodiment of the present disclosure. As can be seen from FIG. 3D, during the reverse allotment mode as as the second mode, in the optical logic circuit according to the third embodiment of the present disclosure, a first output terminal or a fifth output terminal may be controlled to act as an ‘OR’ gate while a sixth output terminal may be controlled to act as a ‘NOR’ gate.

It can be therefore understood that the optical logic circuit according to the third embodiment of the present disclosure may operate as one of the ‘NAND’, ‘AND’, ‘OR’, and ‘NOR’ gates.

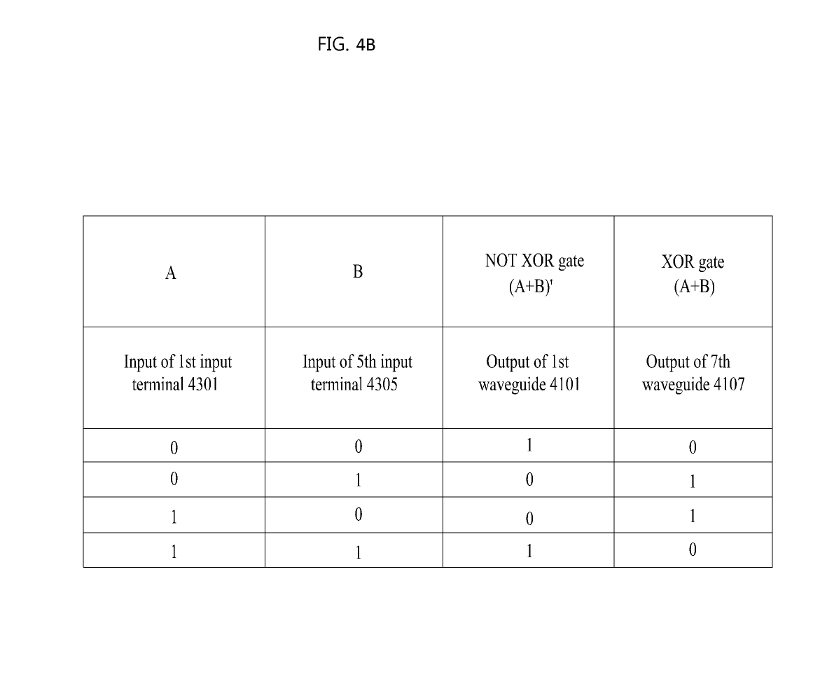

FIGS. 4A and 4B illustrate an optical logic circuit operating with light reflection control, and a table for showing the operation in accordance with a fourth embodiment of the present disclosure.

The optical logic circuit shown in FIG. 4A may further include, in addition to a first waveguide 4101, a second waveguide 4102, and a first reflector 4201 which may be included in the optical logic circuit of the first embodiment, a seventh waveguide 4107 coupling with the second waveguide 4102 and guiding light straight, an eighth waveguide 4108 branching with an angle from the seventh waveguide 4107, and a fourth reflector 4204 disposed on an area, at which the eighth waveguide 4108 branches from the seventh waveguide 4107, and configured to control a refractive index by a fourth input signal of a fourth input terminal 4305. The fourth reflector 4204 may change a refractive index in response to the fourth input signal and control a pathway of light to be selected into one of the seventh waveguide 4107 and the eighth waveguide 4108.

Additionally, the optical logic circuit according to the fourth embodiment of the present disclosure may further include an ninth waveguide 4109 branching with an angle from the first waveguide 4101, and a fifth reflector 4205 disposed on an area, at which the ninth waveguide 4109 branches from the first waveguide 4101, and configured to control a refractive index by a fifth input signal of a fifth input terminal The fifth reflector 4205 may change a refractive index in response to the fifth input signal and control a pathway of light to be selected into one of the first waveguide 4101 and the ninth waveguide 4109.

In detail, in the optical logic circuit according to the fourth embodiment of the present disclosure, an end of the eighth waveguide 4108 may meet and join with the first waveguide 4101 and an end of the ninth waveguide 4109 may meet and join with the seventh waveguide 4107. Additionally, the optical logic circuit according to the fourth embodiment of the present disclosure may use a first input signal, the fifth input signal, and a sixth input signal to adjust a signal of the first output terminal through the first waveguide 4101 and a signal of a seventh output terminal through the seventh waveguide 4107. A fourth input signal and the fifth input signal may be desirably the same signal coupled to the fifth input terminal 4305.

In the optical logic circuit according to the fourth embodiment of the present disclosure, the first reflector 4201 and the fifth reflector 4205 may be coupled in series on the first waveguide 4101 which is a main waveguide, and another one of the fourth reflector 4204 may be installed on the seventh waveguide 4107 which is coupled with the second waveguide 4102 that is a branch waveguide diverged from the first waveguide 4201. With this configuration, the coupling may be provided to control refractive indexes of the fourth reflector 4204 and the fifth reflector 4205 to be coincidently adjusted by an input signal from the fifth input terminal 4305. Additionally, the ninth waveguide 4109, which is a branch waveguide diverged from the fifth reflector 4205, may joint with the seventh waveguide 4107 which is a main waveguide of the fourth reflector 4204, and the eighth waveguide 4108, which is a branch waveguide diverged from the fourth reflector 4204, may joint with the first waveguide 4101 which is a main waveguide of the fifth reflector 4205.

FIG. 4B is a table showing an operation in a forward allotment mode and a reverse allotment mode in the optical logic circuit according to the fourth embodiment of the present disclosure. As can be seen from FIG. 4B, during the forward allotment mode as a first mode, in the optical logic circuit according to the third embodiment of the present disclosure, an output terminal of the first waveguide 4101 may act as a NOT XOR′ gate while an output terminal of the seventh waveguide 4107 may act as an ‘XOR’ gate.

Additionally, during the reverse allotment mode that is a second mode, in the optical logic circuit according to the fourth embodiment, as shown in FIG. 4B, the output terminal of the first waveguide 4101 may have a function of NOT XOR′ gate and the output terminal of the seventh waveguide 4107 may have a function of ‘XOR’ gate. Accordingly, it can be understood that the optical logic circuit of the fourth embodiment may have the same logical function in the reverse allotment and the forward allotment.

Therefore, the optical logic circuit according to the fourth embodiment may operate as a gate one of the NOT XOR′ and ‘XOR’ gates.

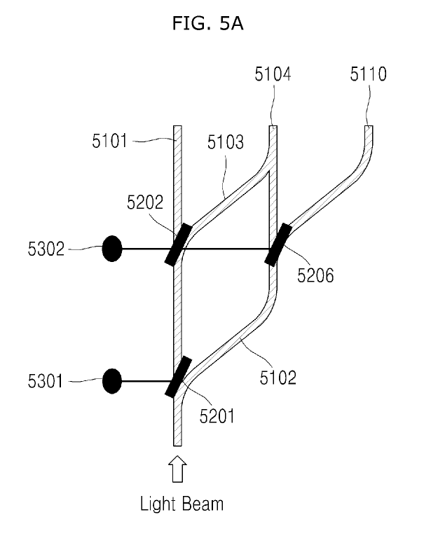

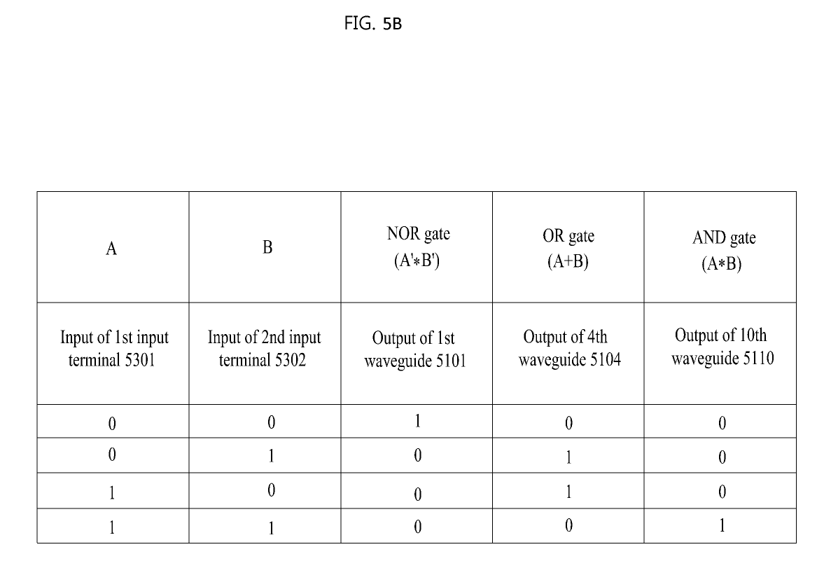

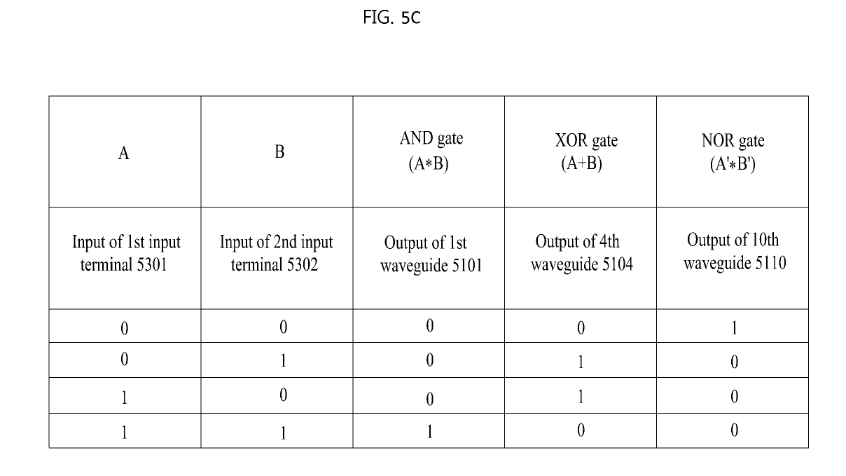

FIGS. 5A to 5C illustrate an optical logic circuit operating with light reflection control, and tables for showing the operations in accordance with a fifth embodiment of the present disclosure.

The optical logic circuit of FIG. 5A may further include, in addition to the optical logic circuit of the third embodiment, a tenth waveguide 5110 branching with an angle from a second waveguide 5102, and a sixth reflector 5206 disposed on an area, at which the tenth waveguide 5110 branches from a second waveguide 5102, and configured to control a refractive index by a sixth input signal. The sixth reflector 5206 may change a refractive index in response to the sixth input signal and control a pathway of light to be selected into one of a fourth waveguide 5104 and the tenth waveguide 5110.

Additionally, the optical logic circuit according to the fifth embodiment of the present disclosure may use a first input signal, a second input signal, and the sixth input signal to control a signal value of a fourth output terminal through a fourth waveguide 5104 and a signal value of a tenth output terminal through the tenth waveguide 5110 to operate as a logic gate. The second input signal and the sixth input signal may feature to be the same signal which is coupled with a second input terminal 5302.

Repeatedly, in the optical logic circuit according to the fifth embodiment of the present disclosure, the first reflector 5201 and the second reflector 5202 may be coupled in series on the first waveguide 5101 and the sixth reflector 5206 as another one may be installed on the fourth waveguide 5104 which is coupled with the second waveguide 5102 that is a branch waveguide diverged from the first reflector 5201. Additionally, this configuration may form the coupling to coincide refractive index control of the sixth reflector 5206 and the second reflector 5202 by the same input signal, a third reflector 5103 which is a branch waveguide diverged from the second reflector 5202 may join with the fourth waveguide 5104 which is a main waveguide of the sixth reflector 5206, and the tenth waveguide 5110 which is a branch waveguide diverged from the sixth reflector 5206 may diverge to be an independent waveguide.

FIG. 5B is a table for showing an operation of the optical logic circuit according to the fifth embodiment of the present disclosure in a forward allotment mode. As can be seen from FIG. 5B, during the forward allotment mode, in the optical logic circuit according to the fifth embodiment of the present disclosure, an output terminal of the first waveguide 5101 may perform a function of ‘NOR’ gate, an output terminal of the fourth waveguide 5104 may perform a function of ‘OR’ gate, and an output terminal of the tenth waveguide 5110 may perform a function of ‘AND’ gate.

And, FIG. 5C is a table for showing an operation of the optical logic circuit according to the fifth embodiment of the present disclosure in a reverse allotment mode. As can be seen from FIG. 5C, during the reverse allotment mode, in the optical logic circuit according to the fifth embodiment of the present disclosure, the output terminal of the first waveguide 5101 may perform a function of ‘AND’ gate, the output terminal of the fourth waveguide 5104 may perform a function of ‘XOR’ gate, and the output terminal of the tenth waveguide 5110 may perform a function of ‘NOR’ gate.

Summarily, the optical logic circuit according to the fifth embodiment of the present disclosure may operate as a gate one of the ‘NOT’, ‘OR’, ‘AND’, and ‘XOR’ gates.

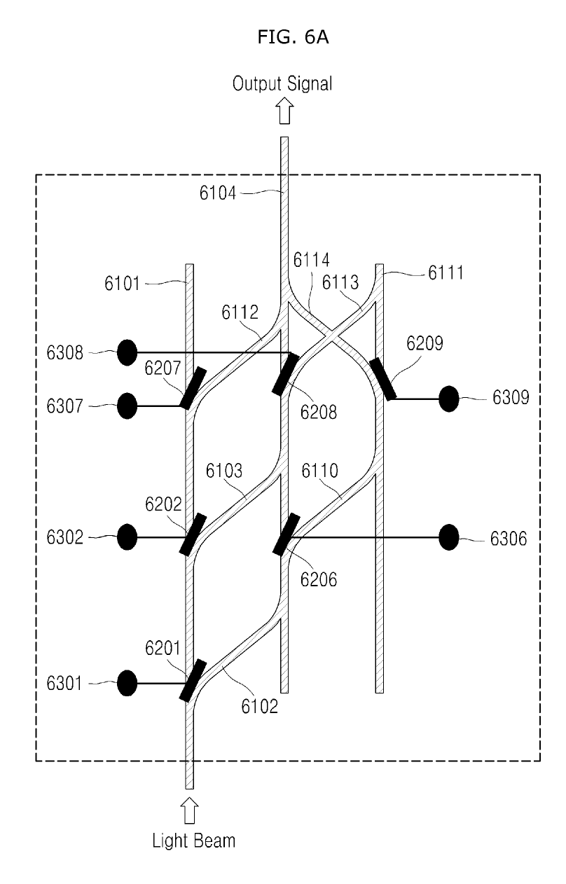

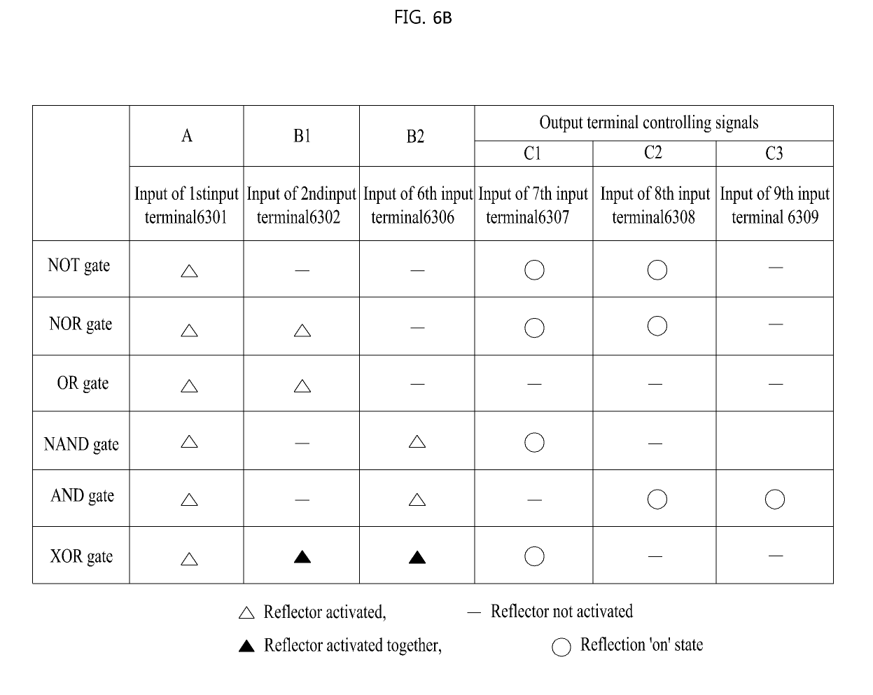

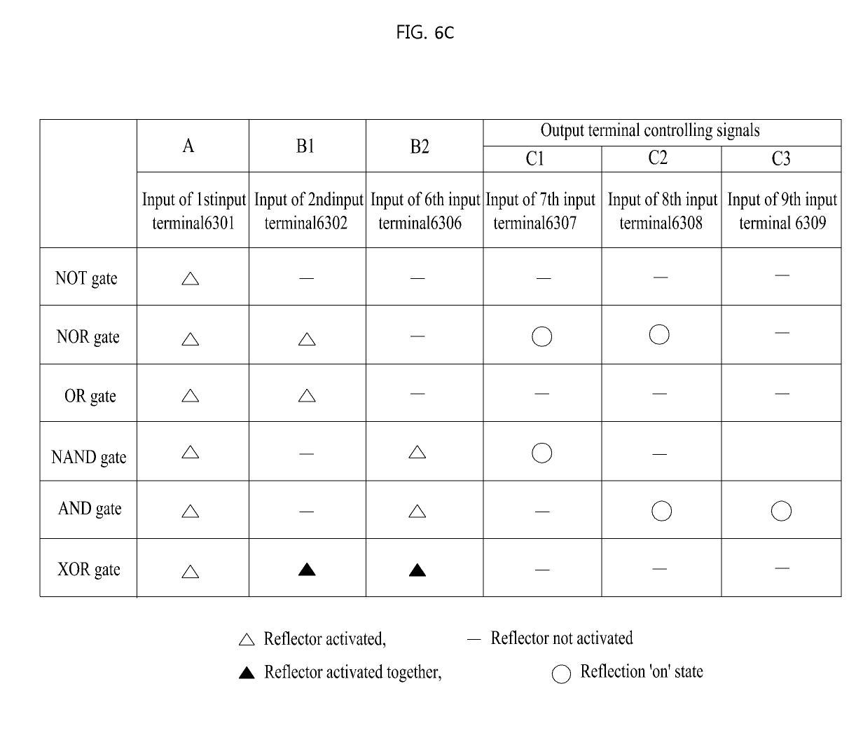

FIGS. 6A to 6C illustrate an optical logic circuit operating with light reflection control, and tables for showing the operations in accordance with a sixth embodiment of the present disclosure.

The optical logic circuit of FIG. 6A may include, in addition to the optical logic circuit of the fifth embodiment, an eleventh waveguide 6111 coupling with a tenth waveguide 6110 and guiding light straight, a fourteenth waveguide 6114 branching with an angle from the eleventh waveguide 6111, a twelfth waveguide 6112 branching with an angle from the first waveguide 6101, and a thirteenth waveguide 6113 branching with an angle from the fourth waveguide 6104. Additionally, the optical logic circuit according to the sixth embodiment of the present disclosure may further include a seventh reflector 6207 disposed on an area, at which the twelfth waveguide 6112 branches from the first waveguide 6101, and configured to control a refractive index by using a seventh input signal of a seventh input terminal 6307, an eighth reflector 6208 disposed on an area, at which the thirteenth waveguide 6113 branches from the fourth waveguide 6104, and configured to control a refractive index by using an eighth input signal of an eighth input terminal 6308, and a ninth reflector 6209 disposed on an area, at which the fourteenth waveguide 6114 branches from the eleventh waveguide 6111, and configured to control a refractive index by using a ninth input signal of a ninth input terminal 6309. The seventh reflector 6027, the eighth reflector 6208, and the ninth reflector 6209 may change refractive indexes in response to their respective input signals, and then control a pathway of light to be selected into one of the main waveguides 6101, 6104, and 6111 and the branch waveguides 6112, 6113, and 6114.

In detail, the optical logic signal according to the sixth embodiment of the present disclosure may feature that an end of the twelfth waveguide 6112 and an end of the fourteenth waveguide 6114 meet and join with the fourth waveguide 6104, and an end of the thirteenth waveguide 6113 meets and joins with the eleventh waveguide 611. Additionally, the seventh input signal, the eighth input signal, and the ninth input signal are used to select a part of the first waveguide 6101, the fourth waveguide 6104, and the eleventh waveguide 6111 as an output terminal for the final signal.

The optical logic circuit according to the sixth embodiment of the present disclosure exemplarily shows a reconfigurable logic circuit cell that may accomplish different logical computations in a single circuit by properly combining the logic circuits of the first through fifth embodiments.

Meantime, the sixth embodiment of FIG. 6A may be different from the fifth embodiment in that the second input signal is isolated from the sixth input signal. Here, the first input signal may be input into the first reflector 6201, the second input signal may be input into the second reflector 6202, and the sixth input signal may be input into the sixth reflector 6206. The important feature of the reconfigurable optical logic circuit shown in FIG. 6A is that the seventh reflector 6207, the eighth reflector 6208, and the ninth reflector 6209 are installed to control output signals of three output terminals to be concentrated on a single output terminal. An output signal after logical computation may be generated from one of ends of those three waveguides 6101, 6104, and 6111. By installing the seventh reflector 6207, the eighth reflector 6208, and the ninth reflector 6209 respectively at ends of the three waveguides 6101, 6104, and 6111, an output signal derived from its corresponding output terminal may be sent to a single output gate.

In detail, FIG. 6A exemplarily illustrates an optical logic circuit of selecting an end of the fourth waveguide 6104 as an output terminal. Together with installment of the seventh reflector 6207, the eighth reflector 6208, and the ninth reflector 6209 which are reflectors for controlling the output terminal, the twelfth waveguide 6112 and the fourteenth waveguide 6114 as branch waveguides of the seventh reflector 6207 and the ninth reflector 6209 may be joined with the fourth waveguide 6104, and the thirteenth waveguide 6113 as a branch waveguide of the eighth reflector 6208 may be detoured toward another output terminal but the fourth waveguide 6104. In FIG. 6A, the eleventh waveguide 6111 is exemplarily selected as a detour. Like this, as shown in FIG. 6A, the the twelfth waveguide 6112, the thirteenth waveguide 6113, and the fourteenth waveguide 6114 may correspond to output-terminal leading waveguides which have output-signal leading functions of transferring an output signal of a desired logic gate to the fourth waveguide 6104 which is the output terminal. The seventh reflector 6207, the the eighth reflector 6208, and the ninth reflector 6209 may correspond to output-terminal controlling reflectors which have functions of selecting an output-terminal leading waveguide.

As aforementioned, by forming the output-terminal controlling reflectors 6207, 6208, and 6209 and an output-signal leading circuit, a desired logical computation output signal may be transferred to an output terminal (the output terminal of the fourth waveguide 6104 in FIG. 6A) and optical signals but the output signal may be gone out of the optical logic circuit by way of extinguishing them at an end of another waveguide.

FIG. 6B is a table for showing an operation of the optical logic circuit according to the sixth embodiment of the present disclosure in a forward allotment mode that is a first mode. As can be seen from FIG. 6B, a reconfigurable optical logic circuit according to the present disclosure may accomplish different logical functions that can be obtained by combinations between selection with the second reflector 6202 and the sixth selector 6206 for inputs of the second input signal and the sixth input signal, and selection with the seventh to ninth reflectors 6207, 6208, and 6209.

In FIG. 6B, ‘Δ’ denotes a reflector selected (activated) for inputting a first input signal, a second input signal, or a sixth input signal, and ‘▴’ denotes a state that the second reflector 6202 and the sixth reflector 6206 for the second input signal and the sixth input signal operate at the same time. Additionally, ‘∘’ denotes an output-terminal controlling reflector which is selected to transfer a desired output signal of logical operation to the output terminal of the fourth waveguide 6104, and ‘-’ denotes an unused (‘off’ state, namely being left in a pass state) reflector. As an example, for the function of ‘NOR’ gate, if the first input signal is input into the first reflector 6201, the second input signal is input into the second reflector 6202, the seventh reflector 6207 and the eighth reflector 6208 which act as the output-terminal controlling reflectors are conditioned in an ‘on’ state (reflection state), and the reset reflectors are conditioned in an ‘off’ state (pass state), an output signal corresponding to ‘NOR’ logical operation may be output through the output terminal of the fourth waveguide 6104. Like this, it can be understood that the optical logic circuit of FIG. 6A may be used to form all of logic gates necessary for logical operation by way of rearrangement of combinations with the reflectors as shown in FIG. 6B.

Additionally, FIG. 6C is a table for showing an operation of the optical logic circuit according to the sixth embodiment of the present disclosure in a reverse allotment mode that is a second mode. As can be seen from FIG. 6C, an optical logic circuit according to the sixth embodiment of the present disclosure may accomplish different logical functions.

As can be understood from the optical logic circuits according to the aforementioned first through sixth embodiments, an optical logic circuit according to the present disclosure may feature as follows.

The optical logic circuit of the present disclosure may include at least two main waveguides which enables light to travel straight, and at least one branch waveguide which diverges from one of the at least two main waveguides and meets and joins with the other of the main waveguides. Additionally, the optical logic circuit of the present disclosure at least one input signal reflector which is disposed on an area, at which a branch waveguide diverges from one of the at least two main waveguides, and configured to control a refractive index by an input signal. The input signal reflector may change a refractive index in response to an input signal, and then control a pathway of light to be selected into one of the at least two main waveguides or a branch waveguide. Additionally, the optical logic circuit of the present disclosure may control a signal value of each output terminal of a main waveguide to operate as a logic gate by using each input signal of the input signal reflector.

Additionally, the optical logic circuit of the present disclosure may be desired to further include at least one output-terminal leading waveguide which branches from one of the least two main waveguides and meets and joins with the other of the two main waveguides, and at least one output-terminal controlling reflector which is disposed on an area, at which the output-terminal leading waveguide branches from one of the least two main waveguides, and configured to control a refractive index by using an output-terminal control signal. The controlling reflector may change a refractive index in response to a control signal and control a pathway of light to be selected into one of at least two main linear waveguides and an output-terminal leading waveguide.

In detail, the optical logic circuit according the sixth embodiment of the present disclosure may feature to control a part of at least two main waveguides to be selected as an output terminal of the final signal in response to a control signal input thereto. Additionally, an input signal reflector and a controlling reflector, according to the present disclosure, may be desired to be the same physical unit. Additionally, a controlling reflector may feature to be disposed by one in each main waveguide.

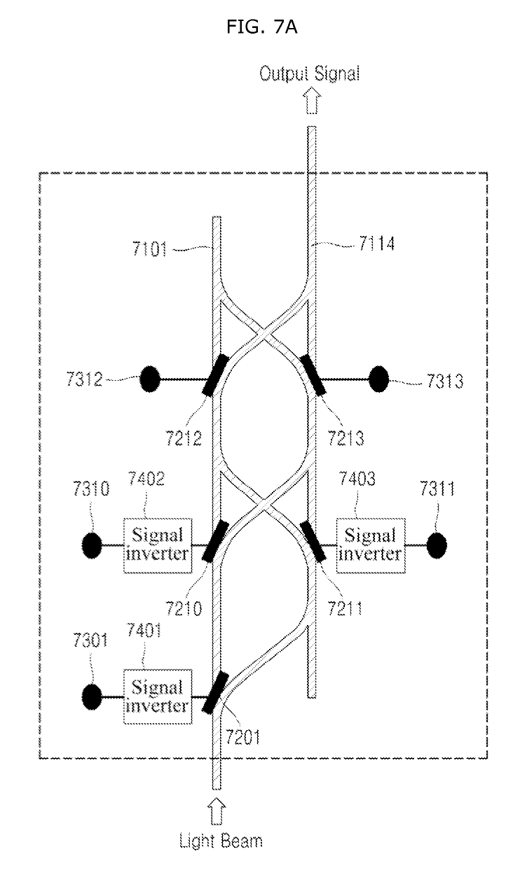

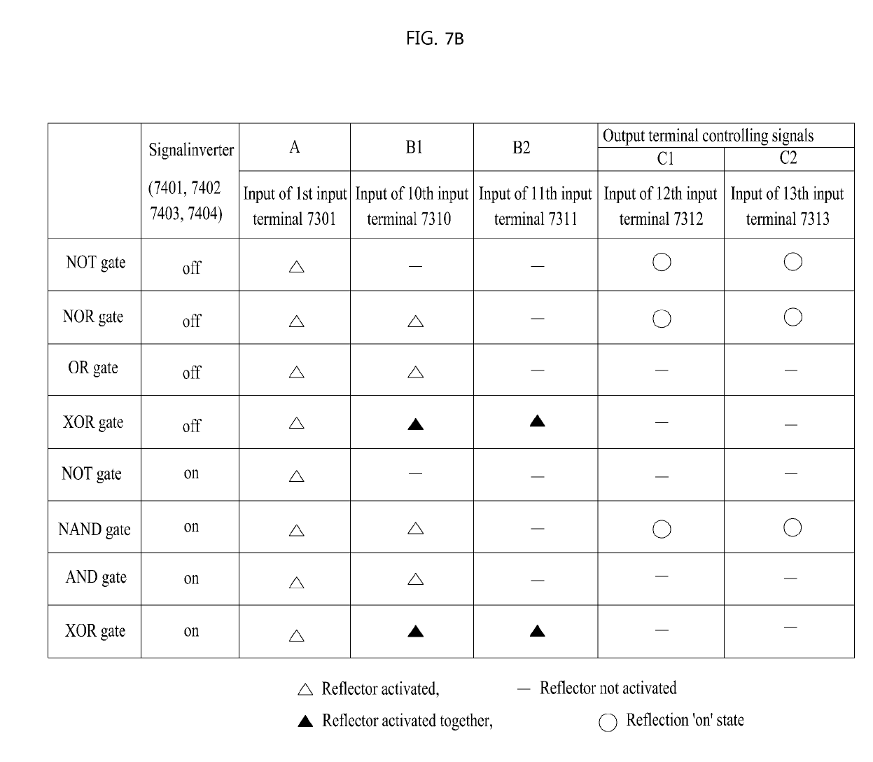

FIGS. 7A and 7B illustrate an optical logic circuit and a table for showing the operation in accordance with a seventh embodiment of the present disclosure.

As can be seen from FIG. 7A, the optical logic circuit according the seventh embodiment of the present disclosure may further include at least one signal inverter 7401, 7402, and 7403 capable of outputting an input signal into a non-inverse signal or an inverse signal. Output signals of the signal inverters 7401, 7402, and 7403 may be input into input terminals 7301, 7310, and 7311 of reflectors 7201, 7210, and 7211, respectively.

The signal inverters 7401, 7402, and 7403 may be directed to more simplify a reconfigurable optical logic circuit by combination with a forward allotment mode and a reverse allotment mode.

In the forward allotment mode for input signals ‘0’ and ‘1’, if the input signal is ‘0’, the signal inverters 7401, 7402, and 7403 control the reflectors 7201, 7210, and 7211 to be turned ‘off, and if the input signal is ‘1’, the signal inverters 7401, 7402, and 7403 control the reflectors 7201, 7210, and 7211 to be turned ‘on’. In the reverse allotment mode, if the input signal is ‘0’, the signal inverters 7401, 7402, and 7403 control the reflectors 7201, 7210, and 7211 to be turned ‘on’, and if the input signal is ‘1’, the signal inverters 7401, 7402, and 7403 control the reflectors 7201, 7210, and 7211 to be turned ‘off’. By installing such signal inverters 7401, 7402, and 7403 ahead of the reflectors 7201, 7210, and 7211, it may be allowable to reduce the number of main waveguides 7101 and 7114, as well as the number of output-terminal controlling reflectors 7212 and 7213, to simplify a configuration of the optical logic circuit.

As can be seen from FIG. 7B, the optical logic circuit according to the seventh embodiment of the present disclosure may show different logical functions that are obtained by combinations between a selection about whether to activate operations of the signal inverters 7401, 7402, and 7403 for adopting the forward allotment mode (the signal inverters in ‘off’ state) and the reverse allotment mode (the signal inverters in ‘on’ state), a selection of the reflectors for inputting a tenth input signal and an eleventh input signal, and a selection of the output-terminal controlling reflectors.

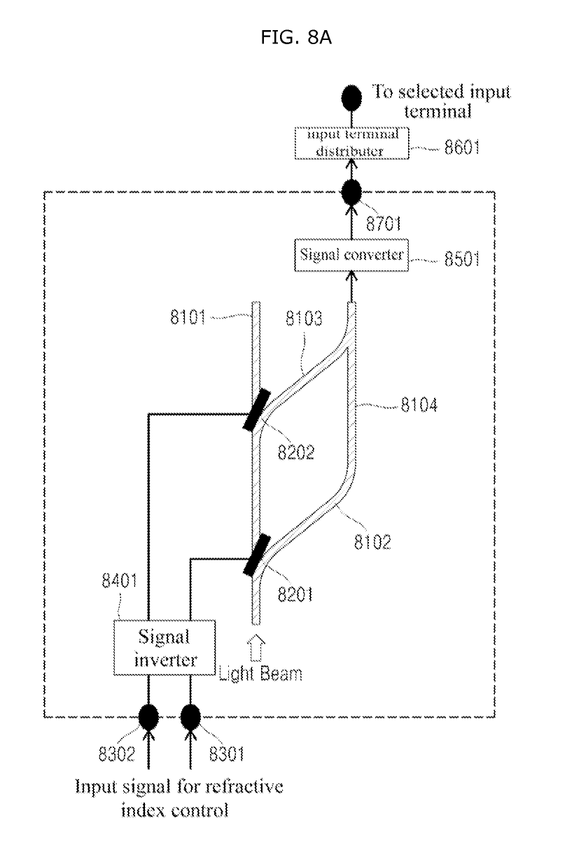

FIG. 8 illustrates an optical logic circuit operating with light reflection control in accordance with an eighth embodiment of the present disclosure. The optical logic circuit according to the eighth embodiment shown in FIG. 8 may be structured to input an output signal, which is obtained from one logic gate, as an input signal for another logic gate, and then perform a successive logical operation, i.e., serial computation.

The rectangle indicated by a dotted line in FIG. 8 may include a series of circuits performing at least one or two or more functions among the unit logical operations such as ‘AND’, ‘OR’, ‘NOR’, and so on which are described with the first to seventh embodiments. But, in the first through seventh embodiments, an output signal obtained from logical performance by the logic gate may be output as an optical signal.

As can be seen from FIG. 8, the optical logic circuit according to the eighth embodiment of the present disclosure may feature to further include a signal converter 8501 and an input terminal distributer 8601. The signal converter 8501 may act to convert a signal, which is output through an output terminal, into a signal which is required from the next input terminal. The input terminal distributer 8601 may allot an optical logic circuit to be used in the next computation, select one from input terminals of the allotted optical logic circuit, and then input a signal as an input signal of a selected input terminal.

In detail, an operation according to the eighth embodiment of the present disclosure with the signal converter 8501 and the input terminal distributer 8601 will be described hereinafter.

The signal converter 8501 may be provided to convert a signal, which is taken from an output terminal of a waveguide, into an input signal of the next optical logic circuit. The signal converter 8501 may be implemented in various ways. In a structure structure that a variation of refractive index in a reflector is controlled by electrical adjustment with voltage or current, a circuit converting an optical signal into an electrical signal may be used to form the signal converter 8501. In a structure that a variation of refractive index is made up by an optical signal itself, a circuit directly outputting the optical signal or turning the optical signal into a level necessary for the variation of refractive index may be used to form the signal converter 8501. A signal output from the optical logic circuit through the signal converter 8501 may be converted into an output signal, which is to be used for controlling a refractive index, and then output through an output terminal. This output signal is transferred to the input terminal distributer 8601. The input terminal distributer 8601 may allot an optical logic circuit which is to be used for the next operation, select one of input terminals A and B of the allotted optical logic circuit, and input a signal as an input signal of the selected input terminal. Like this, it may be allowable to perform a successive logical operation through a coupling step of the optical logic circuit.

In FIG. 8, exemplarily, the input terminal may be prepared in two members 8301 and 8302 and the output terminal may be prepared in one member. In the optical logic circuit, two output signals may be prepared to output a result of 1+1=10 as like a full adder. Accordingly, the input terminal may be prepared to receive three input signals in total, including the two output signals (i.e., for the end position of ‘0’ and the position of ‘1’ that is generated by increment), which is to output a result of such 1+1=10, and a newly additional number. Therefore, depending on a arithmetic function of the optical logic circuit, the number of input terminals may be prepared in two or more while the number of output terminals may be prepared in one or more.

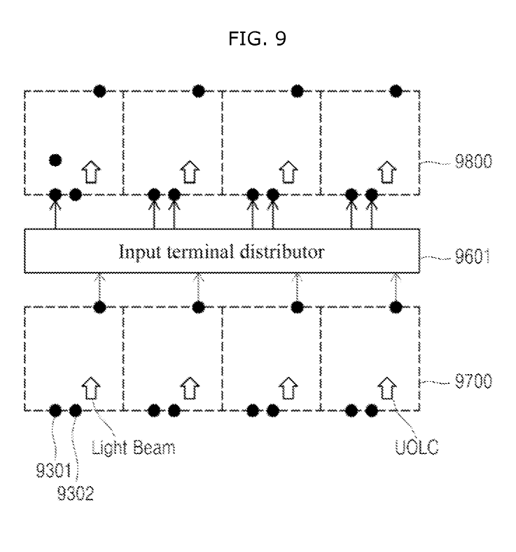

FIG. 9 illustrates an arithmetic device in accordance with an embodiment of the present disclosure.

As can be seen from FIG. 9, the arithmetic device according to the present disclosure may feature to include two or more unit optical logic circuits (ULOCs) which are the same kind of the aforementioned. Additionally, the arithmetic device according to the present disclosure may feature to include a first arithmetic unit 9700 in which one or more UOLCs are coupled in parallel, and a second arithmetic unit 9800 in which one or more ULOCs are coupled in parallel.

The arithmetic device according to the present disclosure may be desired to include an input terminal distributer 9601 for allotting signals, which are provided from one or more parallel output terminals of the first arithmetic unit 9700, into parallel input signals of the second arithmetic unit 9800.

The arithmetic device of FIG. 9 illustrates an exemplary circuit configuration to perform multi-step parallel arithmetic processes necessary for a computing operation. For illustration of a parallel arithmetic process with the aforementioned UOLCs, a logic cell array formed of four ULOCs may be shown as an example, together with a step of turning into the second arithmetic unit 9800, which is the next second logic cell array, after performing a parallel arithmetic process by the first arithmetic unit 9700 which is the first step logic cell array.

The common important feature of the UOLCs may be summarized as follows. First, a light beam with continuous waves used in the optical operation may be incident on each UOLC. Input signals A and B may be input through input terminals into each UOLC. These input signals may be used to control a refractive index of a reflector to perform logical operation in the UOLC. An output signal obtained after the logical operation may be output from each UOLC. This output signal, as described by the UOLC of the eighth embodiment, may be an output signal prepared for rendering an optical output signal, which is obtained from the previous operation, to be used as an input signal of the next step UOLC after the optical output signal passes a signal converter 8501. The output signal may be output through an output terminal.

In the first arithmetic unit 9700 as the first step of the logic cell array, logical operations may be performed in parallel with the input signals A and B of the corresponding UOLC under incidence of the light beam. After the parallel arithmetic process, output signals respectively from the UOLCs may be input into the input terminal distributer 9601, used to select an UOLC, which is to perform the next step logical operation for each output signal, and used to select one of the input terminals A and B of the UOLC. Output signals output after allotment may be input as input signals of the input terminals of the corresponding UOLC to perform the next step logical operation. By way of such a process, the multi-step parallel arithmetic process may be performed.

Since the key process of the logical operation by each UOLC in the arithmetic process shown in FIG. 9 can progress in the rate of ray propagation, it may be permissible to highly shorten a computation rate more than that of an electronic circuit. Additionally, as a light beam, which is continuous light, supplied for computation can be distributively supplied into each UOLC from a single light source, it may be allowable to more simplify a light supply system than a case of employing individual light sources respective to UOLCs.

What is claimed:

1. An optical logic circuit operating with light reflection control, comprising:
a first waveguide configured to have at least a portion formed into a shape of straight line;
a second waveguide configured to branch with an angle from the first waveguide; and
a first reflector configured to change a refractive index by a first input signal and control a pathway of light to be selected into one of the first waveguide and the second waveguide,
wherein the first input signal is used to control a signal value of a first output terminal through the first waveguide and a signal value of a second output terminal through the second waveguide.

2. The optical logic circuit of claim 1, wherein the optical logic circuit is configured to operate in a NOT gate.

3. The optical logic circuit of claim 1, further comprising:
a third waveguide configured to branch with an angle from the first waveguide; and
a second reflector configured to change a refractive index by a second input signal and control a pathway of light to be selected into one of the first waveguide and the third waveguide,
wherein an end of the third waveguide is configured to meet the second waveguide and join with a fourth waveguide; and
wherein the first input signal and the second input signal are used to control a signal value of a first output terminal through the first waveguide and a signal value of a fourth output terminal through the fourth waveguide.

4. The optical logic circuit of claim 3, wherein the optical logic circuit is configured to operate in one or more of NOR, OR, AND, and NAND gates.

5. The optical logic circuit of claim 1, further comprising:
a fifth waveguide configured to couple with the second waveguide and lead light straight;
a sixth waveguide configured to branch with an angle from the fifth waveguide; and
a third reflector configured to change a refractive index by a third input signal and control a pathway of light to be selected into one of the fifth waveguide and the sixth waveguide,
wherein an end of the first waveguide and an end of the fifth waveguide meet to join into one waveguide; and
wherein the first input signal and the second input signal are used to control a signal value of an output terminal of the one waveguide, in which the end of the fifth waveguide and the end of the first waveguide meet and join, and a signal value of a sixth output terminal through the sixth waveguide.

6. The optical logic circuit of claim 5, wherein the optical logic circuit is configured to operate in one or more of NOR, OR, AND, and NAND gates.

7. The optical logic circuit of claim 1, further comprising:
a seventh waveguide configured to couple with the second waveguide and lead light straight;
an eighth waveguide configured to branch with an angle from the seventh waveguide;
a fourth reflector configured to change a refractive index by a fourth input signal and control a pathway of light to be selected into one of the seventh waveguide and the eighth waveguide;
a ninth waveguide configured to branch with an angle from the first waveguide; and
a fifth reflector configured to change a refractive index by a fifth input signal and control a pathway of light to be selected into one of the first waveguide and the ninth waveguide,
wherein an end of the eighth waveguide is configured to meet and join with the first waveguide and an end of the ninth waveguide is configured to meet and an end of the seventh waveguide to join with the seventh waveguide; and
wherein the first input signal, the fourth input signal, and the fifth input signal are used to control a signal value of a first output terminal through the first waveguide and a signal value of a seventh output terminal through the seventh waveguide.

8. The optical logic circuit of claim 7, wherein the fourth input signal couples with the fifth input signal.

9. The optical logic circuit of claim 8, wherein the optical logic circuit is configured to operate in one or more of NOR, OR, AND, and NAND gates.

10. The optical logic circuit of claim 3, further comprising:
a tenth waveguide configured to branch with an angle from the fourth waveguide; and
a sixth reflector configured to change a refractive index by a sixth input signal and control a pathway of light to be selected into one of the fourth waveguide and the tenth waveguide,
wherein the first input signal, the second input signal, and the sixth input signal are used to control a signal value of a first output terminal through the first waveguide, a signal value of a fourth output terminal through the fourth waveguide, and a signal value of a tenth output terminal through the tenth waveguide.

11. The optical logic circuit of claim 10, wherein the second input signal couples with the sixth input signal.

12. The optical logic circuit of claim 11, wherein the optical logic circuit is configured to operate in one or more of NOR, OR, AND, and XOR gates.

13. The optical logic circuit of claim 10, further comprising:
an eleventh waveguide configured to couple with the tenth waveguide and lead light straight;
a twelfth waveguide configured to branch with an angle from the first waveguide;
a thirteenth waveguide configured to branch with an angle from the fourth waveguide;
a fourteenth waveguide configured to branch with an angle from the eleventh waveguide;
a seventh reflector configured to change a refractive index by a seventh input signal and control a pathway of light to be selected into one of the first waveguide and the twelfth waveguide;
an eighth reflector configured to change a refractive index by an eighth input signal and control a pathway of light to be selected into one of the fourth waveguide and the thirteenth waveguide; and
a ninth reflector configured to change a refractive index by a ninth input signal and control a pathway of light to be selected into one of the eleventh waveguide and the fourteenth waveguide,
wherein an end of the twelfth waveguide and an end of the fourteenth waveguide are configured to meet and join with the fourth waveguide; and
wherein an end of the thirteenth waveguide is configured to meet and join with the eleventh waveguide.

14. The optical logic circuit of claim 13, wherein the seventh input signal, the eighth input signal, and the ninth input signal are used to select a part of the first waveguide, the fourth waveguide, and the eleventh waveguide as an output terminal of a final signal to select different logical functions.

15. An optical logic circuit operating light reflection control, comprising:
at least two main waveguides configured to lead light straight;
at least one branch waveguide configured to diverge from one of the at least two main waveguides and meet and join with the other of the at least two main waveguides; and
at least one input signal reflector configured to change a refractive index by an input signal and control a pathway of light to be selected into one of the at least two main waveguides and the branch waveguide,
wherein an input signal of each input signal reflector is used to control a signal value of each output terminal of the main waveguides.

16. The optical logic circuit of claim 15, further comprising:
at least output-terminal leading waveguide configured to branch from one of the at least two main waveguides, and meet and join with the other of the at least two main waveguides; and
at least one output-terminal controlling reflector configured to change a refractive index by a control signal and select a pathway of light to be selected into one of the at least two main waveguides and the output-terminal leading waveguide,
wherein the control signal, which is input, is used to select a part of the at least two main waveguide, which are shaped in a straight line, as an output terminal of a final signal.

17. The optical logic circuit of claim 16, wherein the output-terminal controlling reflector is disposed by at least one in the main waveguide.

18. The optical logic circuit of claim 16, further comprising:
at least one signal inverter configured to output an input signal into a non-inverse signal or an inverse signal,
wherein an output signal of the signal inverter is input into each input terminal of the at least one reflector.

19. The optical logic circuit of claim 16, further comprising:
a signal converter configured to convert a signal, which is output to an output terminal of the final signal, into a signal that is required from the next input terminal.

20. An arithmetic device comprising:
two or more optical logic circuits,
wherein the at least two or more optical logic circuit comprises:
at least two main waveguides configured to lead light straight;
at least one branch waveguide configured to diverge from one of the at least two main waveguides and meet and join with the other of the at least two main waveguides; and
at least one input signal reflector configured to change a refractive index by an input signal and control a pathway of light to be selected into one of the at least two main waveguides and the branch waveguide,
wherein an input signal of each input signal reflector is used to control a signal value of each output terminal of the main waveguides.

21. The arithmetic device of claim 20, further comprising:
a first arithmetic unit in which one or more of the optical logic circuits are coupled in parallel; and
a second arithmetic unit in which one or more of the optical logic circuits are coupled in parallel.

22. The arithmetic device of claim 21, further comprising:
an input terminal distributer configured to one or more of parallel output terminals, which are provided from the first arithmetic unit, into parallel input signals of the second arithmetic unit.
